(19) United States
(12) Patent Application Publication
(10) Pub. No.: US 2024/0199282 A1
(43) Pub. Date: Jun. 20, 2024

(54) Multilayer Tube Laminate with Paper Layer and Protective Coating Arranged Thereon, Tubular Body and Tube

(71) Applicant: Huhtamaki Flexible Packaging Germany GmbH & Co. KG, Ronsberg (DE)

(72) Inventors: Detlev Schulz, Dietmannsried (DE); Daniel Drexler, Haldenwang (DE); Reinhard Lacher, Ronsberg (DE)

(21) Appl. No.: 18/517,368

(22) Filed: Nov. 22, 2023

(30) Foreign Application Priority Data
Dec. 19, 2022 (DE) 10 2022 133 958.0

(51) Int. Cl. B65D 35/08; B32B 1/08; B32B 27/10; B32B 27/32

(52) U.S. Cl. CPC B65D 35/08; B32B 1/08; B32B 27/10; B32B 27/32; B32B 2250/02; B32B 2255/12; B32B 2255/26; B32B 2307/4023; B32B 2307/718; B32B 2307/7242; B32B 2307/7376; B32B 2439/40

(57) ABSTRACT

A multilayer tube laminate for producing a tubular container, having
at least one paper layer,
a sealable exposed polymer layer on one side of the at least one paper layer, and
a polymer coating from an olefin-based material applied directly on the at least one paper layer on an other side of the at least one paper layer facing away from the sealable polymer layer;
   the polymer coating being a protective polymer coating with a weight per area in the range from 0.5 g/m² to 4.9 g/m², where the protective polymer coating is either exposed towards the outside or carries applied printing.

This application claims priority in German Patent Application DE 10 2022 133 958.0 filed on Dec. 19, 2022, which is incorporated by reference herein.

The present invention concerns a multilayer tube laminate for producing a tubular container, comprising
At least one paper layer,
A sealable exposed polymer layer on one side of the at least one paper layer, and
A polymer coating from an olefin-based material applied directly on the at least one paper layer on an other side of the at least one paper layer facing away from the sealable polymer layer.

### BACKGROUND OF THE INVENTION

Such a tube laminate is known from WO 2015/061980 A1. The polymer coating of the paper layer known from this publication exhibits a thickness of 5 to 25 μm and serves for bonding an outer sealing layer which is necessarily present at the state of the art tube laminate with the single paper layer. Between the outer sealing layer and the polymer coating there can additionally be applied a further adhesive layer from essentially the same material as the polymer coating.

WO 2015/061980 A1 deals with preventing or reducing plastic waste which results from the use of tubes as containers for pastes and gels after expiry of their useful life. To this end, WO 2015/061980 A1 suggests reducing the plastic i.e. polymer fraction in the tube laminate, and proposes arranging a paper layer instead of a polymer layer in the tube laminate.

From WO 2021/053043 A1 there is known a tube laminate with at least two paper layers, which either on an outer side exhibits directly an exposed paper layer or a sealable polyolefin layer. A tube laminate with exposed paper layer is practically unusable, since normally a tube is a reclosable container which is opened and closed repeatedly, such that a paper layer exposed towards the outside would be burdened with humidity and/or grease and/or dirt. A paper layer exposed towards the inside would very rapidly be soaked with ingredients of the flowable tube content.

The layer sequence proposed in WO 2021/053043 A1 with exposed EVOH barrier layer is just as poorly usable as a tube laminate. EVOH is normally hydrophilic and should therefore be shielded against humidity and water.

Therefore the tube laminates disclosed in WO 2021/053043 A1 with exposed paper layer and with exposed EVOH barrier layer, presumably involve laminate precursors which are still to be completed into a deployable tube laminate through the arrangement of further layers.

The drawback of the known and actually deployable state of the art tube laminates with a paper layer, is the sealable polymer layer provided on the outside of the tube laminate. The term ‘the outside of the tube laminate’ denotes in the present case that side of the tube laminate which forms the outside of the tube and/or tubular container respectively formed from it.

The sealable polymer layer exhibits in the case of WO 2015/061980 A1 a thickness of at least 30 μm, where the actually used thickness rather lies in a disclosed preferred range from 39 to 45 μm.

The ready-for-use tube laminates known from WO 2021/053043 A1 likewise exhibit a sealable polymer layer made from LDPE with a thickness of 30 μm lying on their outside.

Such sealing layers on the outside of the tube laminate prevent in sorting plants an automated detection of the paper layer. Such automated detection of the paper layer takes place in a manner which is known per se by using near-infrared technology.

When the paper content of a tube laminate is sufficiently high, the tube laminate can be recycled advantageously in a paper recycling stream. To this end, however, the automated detectability of the laminate as a sufficiently paper-containing tube laminate is important. Normally, this detectability is not present optically in the visible spectral range due to applied printing and/or dyeing of outer polymer layers, since the applied printing and/or the dyeing shields the view of a paper layer situated nearest to the outside of the tube laminate.

In many countries an in many instances, as the case may be, faulty detection of a disposed-of tubular container does not lead to recovery of the disposed-of tube but rather to its thermal recycling with the formation of carbon dioxide or to its depositing in a landfill, where the disposed-of tube remains for decades.

### SUMMARY OF THE INVENTION

It is, therefore, the task of the present invention to improve the state of the art as regards tube laminates to the effect that automated detection of the tube laminate or of a tubular container formed from it, as the case may be, as paper-containing is possible, where at the same time a paper surface of the at least one paper layer should not be accessible from outside.

The present invention solves this task in a tube laminate mentioned in the beginning by the polymer coating being a protective polymer coating with a weight per area in the range from 0.5 g/m² to 4.9 g/m², and the protective polymer coating being either exposed towards the outside or carrying applied printing.

Through the application of the polymer coating as a protective polymer coating, the unimpaired use of a tube formed from the tube laminate as reclosable packaging can be ensured, since during storage or use of the tube, humidity, dirt or grease reaching its outer surface are kept away by the protective polymer coating from the paper layer carrying it.

At the same time, the protective polymer coating with a weight per area of less than 5 g/m² is so thin that the currently known methods for detecting the paper layer lying under the protective polymer coating can be applied without impairment. This is also the case even if the protective polymer coating does not form an exposed surface of the tube laminate and thus of the tube formed from it, but instead carries additional applied printing, for instance in order to apply consumer information to the outside of the tube laminate or of the tube formed from it as the case may be, in a manner discernible for consumer. Normally applied printing is likewise very thin, for instance with thicknesses in the single-digit micrometer range, such that even applied printing placed on the protective polymer coating does not impair the automated detection of the tube laminate as paper-containing.

Thus, preferably the protective polymer coating or the protective polymer coating and the applied printing, where appropriate with the interposition of a primer layer between the protective polymer coating and the applied printing in order to increase the adhesion of the applied printing onto the protective polymer coating, is or are the sole layers of the tube laminate arranged on the one side of the paper layer. Where required, a primer layer can also be arranged between the paper layer and the protective polymer coating in order to increase the adhesion of the protective polymer coating to the paper layer. Preferably, however, the protective polymer coating is applied directly onto the paper layer and is in contact with it.

The thin configuration of the protective polymer coating and foregoing considerably thicker polymer sealing layers adjoining it in the direction away from the at least one paper layer, make possible not only the automated detection of the paper layer in the tube laminate as described above and accordingly automated assignment of the tube laminate to a paper-assigned recycling stream, but also helps to achieve the highest possible weight fraction of paper in the tube laminate.

Direct application of the protective polymer coating without interposition of a primer layer is especially simply possible in advantageous further development of the present invention when the protective polymer coating comprises at least one acid-modified olefin, in particular polyolefin, or consists of such. The protective polymer coating can preferably comprise at least one copolymer out of ethylene methacrylic acid copolymer and ethylene methacrylate copolymer or consist of such. Especially preferably, the protective polymer coating comprises an ethylene methacrylic acid copolymer or consists of such. The aforementioned copolymers offer on the one hand good protection from any influence on the tube laminate, in particular on the at least one paper layer of the same, proceeding from the external environment of the tube laminate. On the other, the aforementioned copolymers, first and foremost the especially preferred ethylene methacrylic acid copolymer, offer a high adhesion effect with the paper of the paper layer and also with other polymers, such that the aforementioned copolymers despite their thin coating configuration with a weight per area of 4.9 g/m² or less can be a foundation for sealing with the sealable polymer layer on the one side of the at least one paper layer or with a separate sealing strip, as it is described further below.

In a preferred further development of the present invention, the protective polymer coating exhibits a weight per area in the range from 1 g/m² to 2.5 g/m². This suffices for protecting the paper layer from external influences and further improves the detection quality of automated detection of the paper layer, especially if onto the protective polymer coating there is further placed applied printing, as is usual for tube laminates on there outside.

Preferably, therefore, the aforementioned one side of the tube laminate with the sealable polymer layer is an inner side of the tube laminate and the aforementioned other side of the tube laminate with the protective polymer coating and/or with the applied printing as the case may be is an outer side of the tube laminate.

For adequately informing consumers about the content, quantity, and origin and the like of a substance packaged in the relevant tubular container produced from the tube laminate, the protective polymer coating, as presented above, preferably carries the applied printing. Further preferably, the applied printing is placed directly onto the protective polymer coating, in contact with it. Where required, however, a thin primer layer with a thickness in the single-digit micrometer range, for instance with a thickness of between 0.5 to 6 μm, can be placed between the applied printing and the protective polymer coating in order to increase the adhesion of the applied printing to the protective polymer coating.

The applied printing is further preferably formed from a layer of overprint varnish and a layer region of printing inks arranged between the overprint varnish layer and the protective polymer coating. The overprint varnish serves to protect the printing inks against influences from the external environment.

Preferably, the overprint varnish lies free with its surface facing away from the at least one paper layer, thus preferably forming an outer surface of the tube laminate and of the tube formed from it.

As an especially resistant overprint varnish, there has proved itself an acryl-based varnish, which therefore is preferably chosen as overprint varnish.

Such applied printing, that is, printing inks plus overprint varnish, preferably exhibits a thickness of less than 3 μm. Thus it is ensured that the applied printing together with the protective polymer coating and where applicable an interposed primer layer does not disturb the automated detection of the paper layer as such and/or the detection of the tube laminate as paper-containing, as the case may be, by means of irradiation with near infrared radiation.

Preferably, starting from the surface of the at least one paper layer situated nearest to the other side, no more than 12 μm, especially preferably no more than 9 μm, and even more preferably no more than 6 μm of further coating material are configured in total over the paper layer up to an exposed surface of the tube laminate. The further coating material preferably comprises only the protective polymer coating and the applied printing, where applicable with the interposition of a primer layer. Without the applied printing, preferably no more than the aforementioned maximum 4.9 g/m² of protective polymer coating are applied on the surface of the paper layer situated nearest to the other side. The protective polymer coating then forms a free surface of the tube laminate.

In principle, the sealable exposed polymer layer, which preferably forms the inner side of the tube laminate, can be formed from an arbitrary sealable polymer, in particular from a sealable polyolefin, in particular polyethylene. LMDPE and LLDPE or a blend of LMDPE and HDPE are preferably provided as sealable polyolefins. An advantageous additional barrier layer against migration of volatile substances, such as for instance aromatics, can be advantageously achieved without a further additional layer by the sealable exposed polymer layer comprising a cyclo-olefin copolymer or consisting of such. For example, the exposed sealable polymer layer can be a blend of a cyclic olefin copolymer and a variety of PE, for instance LDPE or LLDPE. Aromatics in particular are often encountered in substances packaged in tubes, since tubes are often used for packaging cosmetics or lifestyle products.

To prevent migration of oxygen and/or of water vapor through the tube laminate, the tube laminate can preferably exhibit at least one barrier layer. The at least one barrier layer preferably comprises a vinyl alcohol polymer and/or metallization and/or a metal oxide or is formed from such a material.

Preferably the tube laminate exhibits over its entire thickness an oxygen permeability of no more than 1.0, preferably of no more than 0.85 cm³/(m²·d·bar), measured in accordance with DIN 53380-3 at 23° C. and 85% relative humidity, and a water vapor permeability of no more than 1.0, preferably of no more than 0.85 g/(m²·d), measured in accordance with ISO 15106-2 at 23° C. and 85% relative humidity.

Ethylene-vinyl alcohol copolymer, polyvinyl alcohol, or butenediol vinyl alcohol copolymer can be used as a vinyl alcohol copolymer with the desired barrier effect. Such a vinyl alcohol polymer barrier layer can for example be arranged between the at least one paper layer and a polymer layer, in particular polyolefin layer, especially preferably polyethylene layer or cyclic olefin copolymer-containing layer, on the one side of the at least one paper layer. Thus the vinyl alcohol polymer barrier layer, according to an embodiment of the present invention, be arranged between the at least one paper layer and the sealable polymer layer.

Furthermore, between the vinyl alcohol polymer barrier layer and the at least one paper layer there can be arranged a further polymer layer, for instance from a polymer which increases the adhesion of the barrier layer to the paper layer.

On the one side of the paper layer, that is, on the side of the paper layer facing away from the protective polymer coating, in the layer sequence of the tube laminate there can if required be arranged one or several adhesive layers.

A metallization is preferably configured as a metallization coating deposited from a vapor phase. It can be deposited directly onto the at least one paper layer. If the at least one paper layer comprises more than one paper layer, the metallization coating is preferably deposited onto a further paper layer which is arranged at a distance from the paper layer situated nearest to the protective polymer coating. In principle, it makes no difference to the barrier effect of the metallization whether the metallization is arranged on the side nearer to the sealable polymer layer or on the side nearer to the protective polymer coating of the further paper layer. Since, however, normally the metallization should prevent migration of oxygen and water vapor from the external environment into the packaging space of a tubular container, preferably the metallization is arranged on the side of the further paper layer facing the protective polymer coating.

Any metal can be used as metal precipitated from the vapor phase, for instance through vacuum vapor deposition. Preferably, aluminum or an aluminum alloy is used to form the metallization.

For a metal oxide barrier layer, often also denoted a ‘ceramic’ barrier layer, the aforementioned statements regarding metallization apply mutatis mutandis. The metal oxide barrier layer too, is preferably precipitated from a vapor phase, for example through vacuum vapor deposition, on a substrate, preferably on a further paper layer. Possibilities for a metal oxide for configuring the barrier layer include at least a metal oxide consisting of aluminum oxide and silicone oxide.

A metal or metal oxide barrier layer precipitated from the vapor phase can, the above description with a paper layer as substrate layer notwithstanding, also be deposited on a polymer film which can be bonded with another layer of the tube laminate, in particular with the at least one paper layer, through adhesion lamination by means of a solvent-based adhesive or through extrusion lamination by means of a thermally softened thermoplastic synthetic.

The present tube laminate preferably exhibits a weight per area in the range from 200 g/m² to 450 g/m², in order to be able to provide sufficient stability of a tubular container without unnecessary packaging weight.

The weight per area of the at least one paper layer in the tube laminate preferably lies in the range from 80 g/m² to 350 g/m².

For recovery of the tube laminate in a paper-assigned recycling stream, it is preferable if the weight fraction of the at least one paper layer out of the total weight per area of the tube laminate is at least 75%. Especially preferably, the weight fraction of the at least one paper layer out of the total weight per area of the tube laminate is at least 80%, even more preferably at least 85%.

The tube laminate can exhibit exactly one paper layer. Its weight per area then lies preferably in the range from 120 to 250 g/m², preferably from 150 to 200 g/m². The tube laminate can also exhibit more than one paper layer. Preferably one of the paper layers then carries the aforementioned barrier layer.

The present invention further concerns a tubular body formed from a tube laminate, as above described and further developed.

The tubular body comprises a tube laminate blank, which in a manner that is known per se is rolled about a tubular body longitudinal axis, where the end regions of the tube laminate blank which face towards one another in the circumferential direction about the tubular body longitudinal axis are bonded with one another through sealing, forming a sealed seam running in the direction along the tubular body longitudinal axis. The tubular body can exhibit at least section-wise along the tubular body longitudinal axis a lumen cross-section which is constant in shape and/or size in a sectional plane considered orthogonally to the tubular body longitudinal axis and/or the tubular body can exhibit at least section-wise a lumen cross-section which increases along the tubular body longitudinal axis. The lumen cross-section is the area bordered by the tubular body in the relevant sectional plane orthogonal to the tubular body longitudinal axis.

Due to the tubular body encircling the longitudinal direction of the tubular body, the tubular body longitudinal axis defines an axial direction proceeding in parallel to it, a circumferential direction encircling it, and radial directions proceeding orthogonally away from it.

The sealed seam can either
i) be an overlap sealed seam, in which the sealable polymer layer overlaps the protective polymer coating in an overlap region, where the overlap region extends in the circumferential direction and in the direction along the tubular body longitudinal axis, and where the sealable polymer layer and the protective polymer coating are firmly bonded with one another in the overlap region, or can
ii) be a butt sealed seam, in which the end regions which face towards one another in forming a butt joint which proceeds in the direction along the tubular body longitudinal axis and radially away from the tubular body longitudinal axis, approach one another butt-to-butt where the butt joint on at least one radial side with respect to the tubular body longitudinal axis is covered by a sealing strip which extends along the butt joint, spans the butt joint in the circumferential direction, and on each of the two circumferential sides of the butt joint is firmly bonded with an exposed surface section.

Preferably there is provided on each of the two radial sides of the butt joint a sealing strip which extends along the butt joint, covering it, and which in the circumferential direction on each of the two sides of the butt joint is firmly bonded with an exposed surface section of the tubular body.

The at least one sealing strip is preferably a strip with a surface formed by polyolefins, where the surface, under arrangement of the sealing strip at the tubular body, is in contact with the exposed surface of the tubular body. Although in principle the firm bonding of the sealing strip with the tubular body can be achieved by gluing, firm bonding through thermal sealing is preferable. On the outside of the tubular body, in the event of a butt sealed seam being configured, the surface section of the tubular body in contact with the sealing strip and/or the end regions of the rolled tube laminate blank which are to proceed onto one another in the circumferential direction, as the case may be, are preferably left free from applied printing in order to allow direct contacting of the protective polymer coating by the sealing strip, thus achieving higher bonding firmness of the sealing strip with the tubular body.

The present invention concerns besides a tube with a tubular body, which is configured as described above.

The tubular body is bonded with a tube top which exhibits at least one exposed surface made from a polyolefin encircling the tubular body longitudinal axis, where an exposed surface of the tubular body is firmly bonded through sealing with the encircling exposed surface of the tube top.

The terms ‘tubular container’ and ‘tube’ uses present application synonymously.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A schematic cross-sectional view of a first embodiment of a tube laminate according to the invention,

FIG. 2 A schematic cross-sectional view of a second embodiment of a tube laminate according to the invention,

FIG. 3 A schematic cross-sectional view of a first embodiment of a tubular body when considering a sectional plane orthogonal to a tubular body longitudinal axis,

FIG. 4 A schematic cross-sectional view of a second embodiment of a tubular body when considering a sectional plane orthogonal to a tubular body longitudinal axis, and

FIG. 5 A rough schematic elevation view of a tube formed from a tube laminate of FIG. 1 or 2.

The depictions in the drawings are not to scale.

### DESCRIPTION OF PREFERRED EMBODIMENTS

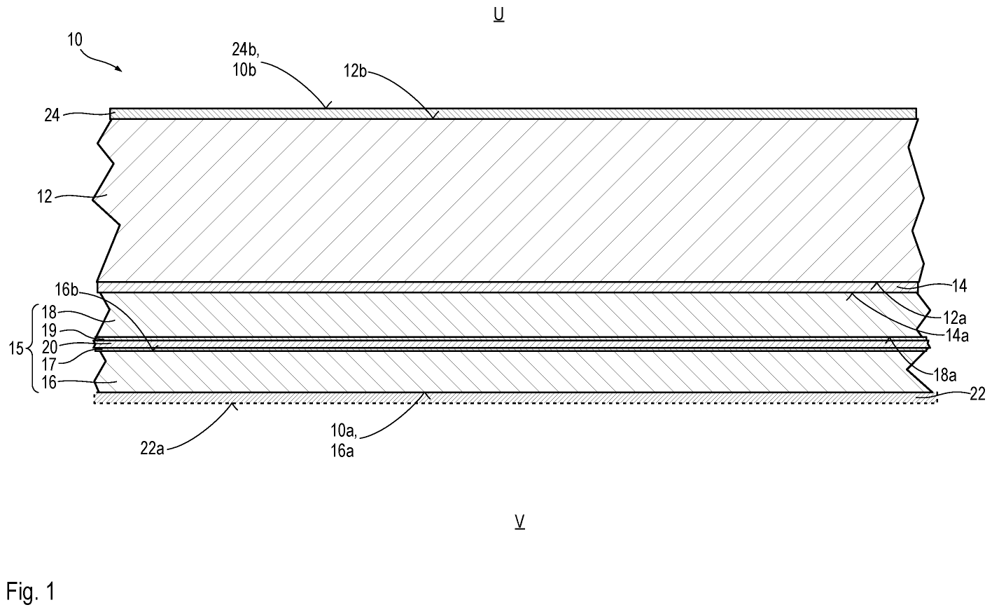

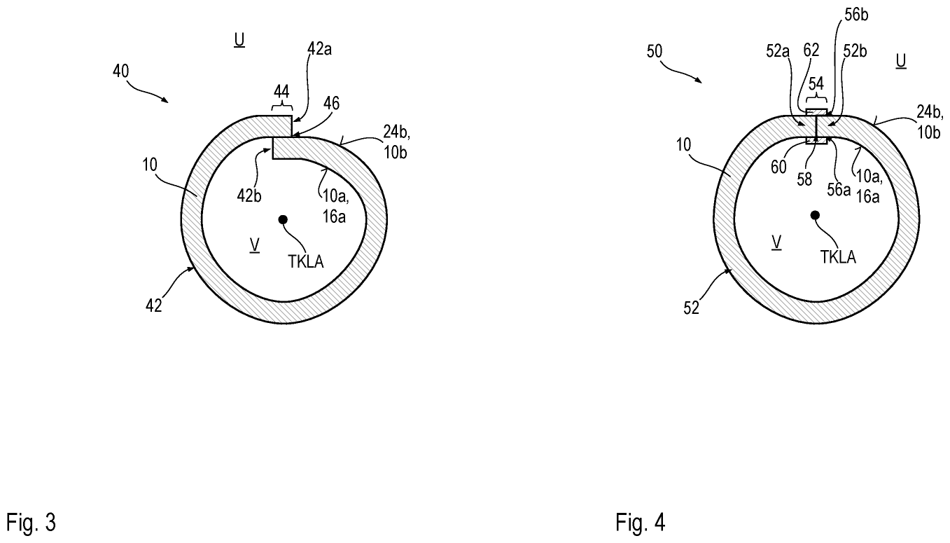

Referring now to the drawings wherein the showings are for the purpose of illustrating preferred and alternative embodiments of the invention only and not for the purpose of limiting the same, in FIG. 1, a first embodiment of a tube laminate according to the invention is denoted generally by 10. The tube laminate 10 exhibits an inner side or inner surface 10a facing towards a packaging space V of a tubular container formed from the tube laminate 10 and exhibits on the tubular container formed from the tube laminate 10 an outer side or outer surface 10b exposed towards the external environment U (see also FIGS. 3 and 4).

The tube laminate 10 of the first embodiment exhibits a single paper layer 12 with a preferred weight per area of 150 to 200 g/m². On its one side 12a there is applied on the paper layer 12 by means of wet printing, a layer 14 of a water-based wet laminating adhesive, for instance casein-based, for instance with a roller. The weight per area of the adhesive layer 14 is preferably between 2 and 10 g/m².

On the side 14a of the adhesive layer 14 which faces away from the paper layer 12 there is arranged a multilayer combined barrier and sealing film 15, which is bonded with the paper layer 12 by the adhesive layer 14.

The combined barrier and sealing film 15 is formed through coextrusion of all the layers contained in it and exhibits a layer 16 made from LMDPE or from a blend of LMDPE and HDPE, a polyethylene layer 18, preferably made from a blend of LMDPE and HDPE, and a barrier layer 20 made from ethylene-vinyl alcohol copolymer (EVOH) arranged between the sealable layer 16 and the polyethylene layer 18.

Solely for the sake of completeness let it be mentioned that the barrier layer 20 is bonded through an interposed adhesive coating 17 or 19 as the case may be consisting of a maleic acid anhydride-based adhesive both with the surface 16b of the sealable polyethylene layer 16 facing towards it and with the surface 18a of the polyethylene layer 18 facing towards it.

When both the sealable polyethylene layer 16 and the polyethylene layer 18 are formed from an HDPE-containing blend, the HDPE content, for instance in percent by weight, in the polyethylene layer 18 is preferably higher than in the sealable polyethylene layer 16. Through the higher HDPE content, the polyethylene layer 18 should exhibit higher stiffness and lower water vapor permeability than the sealable polyethylene layer 16. The barrier layer 20 made from EVOH decreases the oxygen permeability of the barrier film 15 and the polyethylene layers 16 and 18, the polyethylene layer 18 to a greater extent, decrease the water vapor permeability of the barrier film 15.

The combined barrier and sealing film 15 exhibits a thickness in the range from 30 to 70 μm, preferably from 40 to 60 μm.

The sealable layer 16 itself exhibits a sealable surface 16a, forming the surface 10a of the tube laminate 10 which is exposed towards the packaging space V. On the layer 16, more precisely on its surface 10a which faces away from the paper layer 12 and lies nearer to the packaging space V, there can alternatively be configured a sealable polymer layer 22 made from cyclo-olefin copolymer (COC) which is indicated in FIG. 1 merely by a dotted line, for example with a layer thickness of 5 to 20 μm. The polymer layer 22 can be extruded onto the surface 10a of the LDPE film 16. In this case, the surface 22a of the polymer layer 22 made from COC and lying nearer to packaging space V form the surface of the tube laminate 10 which is exposed towards the packaging space V. If, however, the sealable layer 16 is already configured with a sealable surface, preferably the sealable surface 16a is also the surface 10a of the tube laminate 10 which is exposed towards the packaging space V.

On its other side 12b there is applied onto the paper layer 12 a protective polymer coating 24 which preferably is made from ethylene-methacrylic acid copolymer, namely with a preferred thickness of 1 to 2.5 g/m², especially preferably of approximately 2 g/m². The protective polymer coating 14 protects the paper layer 12 against influences from the external environment U and at the same time allows, due to its low thickness, radiation-based detection of the paper layer 12, which makes possible automated feeding of the tube laminate 10 to a paper-assigned recycling stream.

The protective polymer coating 24 is applied by printing, for example through a pressure roller. Consequently, the application is a wet process.

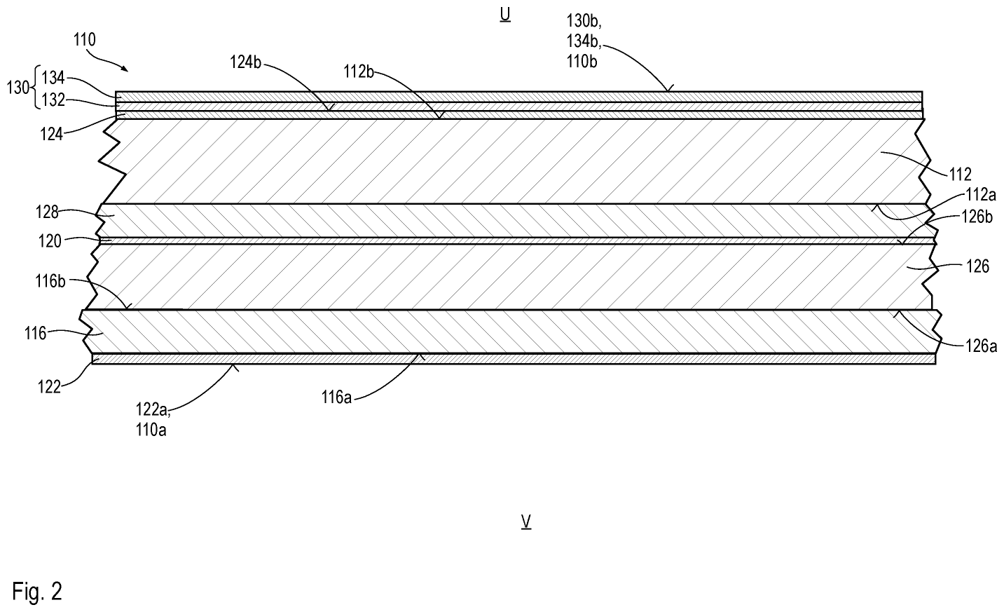

In FIG. 2 there is depicted in cross-section an alternative second embodiment of a tube laminate 110 according to the invention. Identical and functionally identical components and component sections as in FIG. 1 are labelled in FIG. 2 by the same reference symbols, but increased numerically by 100. The second embodiment depicted in FIG. 2 is described below only in so far as it differs from the first embodiment, to whose description express reference is otherwise made also for elucidating the second embodiment.

The tube laminate 110 of the second embodiment exhibits not only one paper layer 112, but instead exhibits additionally a second paper layer 126. The second paper layer 126 exhibits on its side 126b which faces towards the external environment U the barrier layer 120 as a layer made from polyvinyl alcohol (PVOH).

The paper layer 112 and the second paper layer 116 with the barrier layer 118 arranged on the latter are bonded through extrusion lamination by means of an extrusion laminating layer 128 made from polyethylene and/or ethylene-based copolymers. The extrusion laminating layer 128 for bonding the two paper layers 112 and 126 exhibits a weight per area of between 10 g/m² and 30 g/m².

The paper layer 112 exhibits a weight per area of between 40 g/m² and 150 g/m². The second paper layer 126 likewise exhibits a weight per area of between 40 g/m² and 150 g/m², which however does not mean that the first and the second paper layer 112 and 126 always have to exhibit the same weight per area.

In the present second embodiment example, the polyethylene layer 116 is not arranged as a blown film or a cast film as in the first embodiment example, but instead is coextruded with the sealable layer 122 from COC. The two layers 116 and 122 exhibit together a layer arrangement thickness of between 20 μm to 50 μm. The layer 116 can, as in the first embodiment example, be formed from LMDPE or from a blend of LMDPE and HDPE, but for process engineering considerations the coextrusion is preferably formed from LDPE or even more preferably from LLDPE. The exposed surface 122a of the sealable COC layer 122 forms the inner surface 110a of the tube laminate 110 of the second embodiment.

On the surface 124b of the protective polymer coating 124 facing away from the paper layer 112 there is applied by printing an applied printing 130. This applied printing 130 exhibits a layer region with applied printing ink 132 and an acryl-based overprint varnish 134 which covers the applied printing ink 132 towards the external environment U. The applied printing ink 132 is therefore situated between the overprint varnish 134 and the protective polymer coating 124. An exposed surface 134b of the overprint varnish facing towards the external environment U forms the outer surface 110b of the tube laminate 110 of the second embodiment.

The applied printing 130 exhibits a thickness of less than 3 μm.

Despite the applied printing 130 on the protective polymer coating 124, the spacing between the outer surface 110b of the tube laminate and the surface 112b facing towards the external environment U of the paper layer 112 nearest to the external environment is so small, maximum 5 to 7 μm, that detection of the tube laminate 110 as paper-containing through irradiation with radiation in the near infrared wavelength range is possible without problems.

In FIG. 3 there is shown roughly schematically a cross-section of a first embodiment of a tubular body 40 which is formed from the tube laminate 10 of the first embodiment example of FIG. 1. The tubular body 40 extends in the depiction as an idealized cylindrical tubular body 40 along a tubular body longitudinal axis TKLA, which runs orthogonally to the drawing plane of FIG. 3.

A tubular body blank 42 of the tube laminate 10 is rolled in the circumferential direction about the tubular body longitudinal axis TKLA, wherein after the rolling end regions 42a and 42b, which face towards one another in the circumferential direction of the tubular body blank 42, overlap in an overlap region 44. In the overlap region 44, the sealable inner surface 10a of the tube laminate 10 overlies the outside 10b formed by the protective polymer coating 24. Due to the choice of materials, for example LDPE, LLDPE, or COC for the inner surface 10a of the tube laminate 10 and ethylene-methacrylic acid copolymer for the protective polymer coating 24, the inner surface 10a and the outer surface 10b are thermally sealable with one another, such that in the overlap region 44 an overlap sealed seam 46 can be formed through which the inner surface 10a and the outer surface 10b of the tube laminate 10 can be firmly bonded with one another.

The overlap sealed seam 46 extends over the entire overlap region 44, that is, essentially over the entire axial length of the tubular body 40 with respect to the tubular body longitudinal axis TKLA and in the circumferential direction along the actually existing overlap of the two end regions 42a and 42b of the tubular body blank 42.

In FIG. 4 there is shown roughly schematically a cross-section of a second embodiment of a tubular body 50, which again is formed from the tube laminate 10 of the first embodiment examples of FIG. 1. The tubular body 50 of the second embodiment also extends in the depiction as an idealized cylindrical tubular body 50 along a tubular body longitudinal axis TKLA, which proceeds orthogonally to the drawing plane of FIG. 4. The tubular body 50 of FIG. 4 is preferable to the tubular body 40 of FIG. 3 due to the expected higher bonding safety.

A tubular body blank 52 of the tube laminate 10 is again rolled in the circumferential direction about the tubular body longitudinal axis TKLA, wherein after the rolling end regions 52a and 52b, which face towards one another in the circumferential direction of the tubular body blank 52, face each other butt-to-butt, forming a butt joint 58 extending along the tubular body longitudinal axis TKLA, preferably even in parallel to it. Consequently, no overlap of the end regions 52a and 52b takes place.

The butt joint 58 is covered at each of its two radial sides with a sealing strip 60 and 62 respectively in such a way that each sealing strip extends along the butt joint 58 over essentially its entire axial length with respect to the tubular body longitudinal axis TKLA and spanning the butt joint 58 in the circumferential direction on the exposed surfaces of the end regions 52a and 52b. Consequently, the sealing strips 60 and 62 overlap the end regions 52a and 52b in an overlap region 54.

The radially inner sealing strip 60, whose longitudinal direction likewise proceeds orthogonally to the drawing plane of FIG. 4, contacts the inner surface 10a of the tube laminate 10 in the two circumferential end regions 52a and 52b. The radially outer sealing strip 62, whose longitudinal direction likewise proceeds orthogonally to the drawing plane of FIG. 4, contacts the outer surface 10b of the tube laminate 10 in the two circumferential end regions 52a and 52b.

The sealing strips 60 and 62 are preferably constructed identically. They exhibit on their side which contacts the tubular body 50 a sealable layer from a polyolefin, preferably from polyethylene, such as for instance LDPE and LLDPE. The sealable layer from polyolefin can be stabilized through a substrate layer. For example from a layer of polyolefin, such as for instance HDPE or BOPP.

The sealing strips 60 and 62 are each firmly bonded through thermal sealing with the surface contacted by them of the tube laminate 10 or of the tubular body 50 as the case may be. The sealing strip 60 forms with the inner surface 10a of the tube laminate 10 at the end regions 52a and 52b a part-butt sealed seam 56a spanning the butt joint 58, whereas the sealing strip 62 forms with the outer surface 10b of the tube laminate 10 at the end regions 52a and 52b a part-butt sealed seam 56b spanning the butt joint 58. The part-butt sealed seams 56a and 56b form together a butt sealed seam.

If the outside 10b of the tube laminate 10 is formed through applied printing, the latter is omitted in the overlap region 44 on the radially inner overlapping end section 42b and/or in the overlap section 54 respectively, so that sealable polymer surfaces can touch each other directly there.

The tubular bodies 40 and 50 of FIGS. 3 and/or 4 respectively can be formed, instead of with the tube laminate 10 of the first embodiment example, with the tube laminate 110 of the second embodiment example.

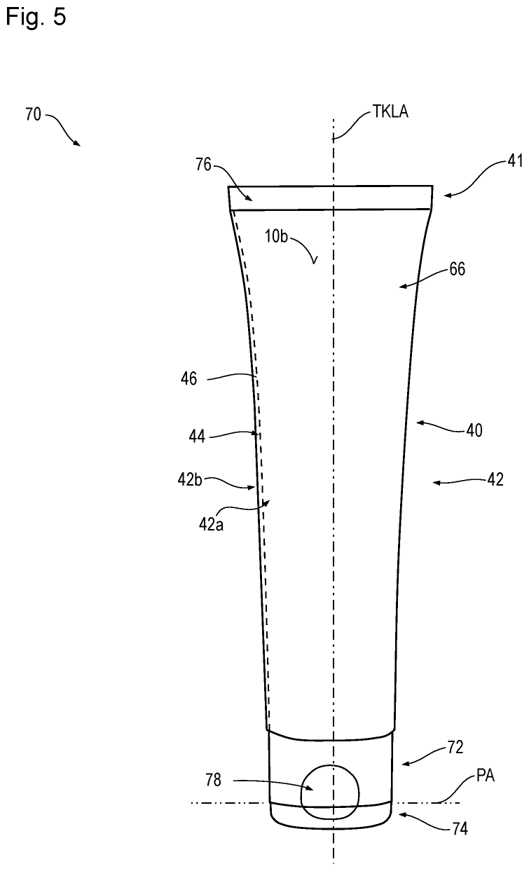

FIG. 5 shows a schematic front view of a tubular container 70 exhibiting a tubular body 40 made from the multilayer tube laminate 10 and a shoulder 72, where the shoulder 72 in the depicted example is configured integrally with a pivotable cap 74 on which the tubular container 70 can stand. Alternatively, the tubular body 40 can also be produced from the second embodiment of the multilayer tube laminate 110. Equally, instead of the tubular body 40 with an overlap sealed seam, a tubular body 50 with a butt sealed seam could be used in the tubular container 70. The latter is even preferable.

For producing the tubular body 40, as already described in connection with FIGS. 3 and 4, a cutting or blank 42 as the case may be of the multilayer tube laminate 10 is rolled around a mandrel such that the end regions 42a and 42b of the rolled blank 42 which are on the end side in the circumferential direction overlap. In the overlap region 44 thus created, the inner surface 10a overlaps the outer surface 10b axially along the tubular body longitudinal axis TKLA and in the circumferential direction around the tubular body longitudinal axis TKLA. The two end regions 42a and 42b are bonded in the overlap region 44 through hot sealing, in order to form the described overlap sealed seam 46.

At the longitudinal end 41 facing away from the shoulder 72, the tubular body 40 is sealed by a fin sealed seam 76. Unlike the overlap sealed seam 46, where the inner surface 10a is sealed with the outer surface 10b of the tube laminate 10, in the fin sealed seam 76 opposite regions of the inner surface 10a are sealed with one another.

At the longitudinal end near the shoulder 72, the tubular body 40 part of the shoulder 72 and overlaps this part in the axial direction with respect to the tubular body longitudinal axis TKLA and in the circumferential direction completely. The overlapping parts of the tubular body 40 and of the shoulder 72 are likewise bonded through hot sealing. To this end, the shoulder 72 is preferably made from injection molded polyethylene, such that the materials of the shoulder 72 and of the sealable layer 16 or 22 of the multilayer tube laminate 10, which form the inner surface 10a of the tube laminate 10, are compatible with one another.

The cap 74 is pivotable about a pivot axis PA, e.g. through a film hinge which connects the cap 74 integrally with the shoulder 72. A depression 78 facilitates the gripping and lifting of the cap 74 off the shoulder 72, in order to open the tubular container 70.

Instead of a cap 74 bonded integrally with the shoulder 72, the cap can be formed separately from the shoulder and for example be screwable onto it and unscrewable from it.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-14. (canceled)

15. A multilayer tube laminate for producing a tubular container, comprising
at least one paper layer,
a sealable exposed polymer layer on one side of the at least one paper layer, and
a polymer coating from an olefin-based material applied directly on the at least one paper layer on an other side of the at least one paper layer facing away from the sealable polymer layer,
wherein the polymer coating is a protective polymer coating with a weight per area in the range from 0.5 g/m² to 4.9 g/m², and where the protective polymer coating is either exposed towards the outside or carries applied printing.

16. The multilayer tube laminate according to claim 15, wherein the protective polymer coating comprises at least one acid-modified olefin or consists of such.

17. The multilayer tube laminate according to claim 15, wherein the protective polymer coating exhibits a weight per area in the range from 1 g/m² to 2.5 g/m².

18. The multilayer tube laminate according to claim 15, wherein the protective polymer coating carries applied printing which is formed from a layer of overprint varnish and a layer region of printing inks arranged between the overprint varnish layer and the protective polymer coating, where the overprint varnish is exposed with its surface facing away from the at least one paper layer.

19. The multilayer tube laminate according to claim 18, wherein the applied printing exhibits a thickness of less than 3 μm.

20. The multilayer tube laminate according to claim 19, wherein the overprint varnish is an acryl-based varnish.

21. The multilayer tube laminate according to claim 18, wherein the overprint varnish is an acryl-based varnish.

22. The multilayer tube laminate according to claim 15, wherein the sealable exposed polymer layer comprises a polyethylene and/or a cyclo-olefin copolymer or consists of such material.

23. The multilayer tube laminate according to claim 15, wherein the tube laminate exhibits at least one barrier layer for reducing an oxygen permeability and/or a water vapor permeability of the tube laminate, where the at least one barrier layer comprises a vinyl alcohol polymer and/or a metallization and/or a metal oxide or is formed from such material.

24. The multilayer tube laminate according to claim 15, wherein the tube laminate exhibits a weight per area in the range from 200 g/m² to 450 g/m².

25. The multilayer tube laminate according to claim 15, wherein the weight per area of the at least one paper layer in the tube laminate lies in the range from 80 g/m² to 350 g/m².

26. The multilayer tube laminate according to claim 15, wherein the weight fraction of the at least one paper layer out of the total weight per area of the tube laminate is at least 75%,

27. The multilayer tube laminate according to claim 23, wherein the tube laminate exhibits more than one paper layer, where one of the paper layers carries the barrier layer.

28. A tubular body formed from a tube laminate according to claim 15, where the tubular body comprises a tube laminate blank which is rolled about a tubular body longitudinal axis, where end regions of the tube laminate blank which face towards one another in the circumferential direction about the tubular body longitudinal axis are bonded with one another through sealing, forming a sealed seam running in the direction along the tubular body longitudinal axis, where the sealed seam either
i) is an overlap sealed seam in which the sealable polymer layer overlaps the protective polymer coating in an overlap region, where the overlap region extends in the circumferential direction and in the direction along the tubular body longitudinal axis and where the sealable polymer layer and the protective polymer coating are firmly bonded in the overlap region with one another, or
ii) is a butt sealed seam, in which the end regions which face towards one another in forming a butt joint which proceeds in the direction along the tubular body longitudinal axis and radially away from the tubular body longitudinal axis, approach one another where the butt joint on at least one radial side with respect to the tubular body longitudinal axis is covered by a sealing strip which extends along the butt joint, spans the butt joint in the circumferential direction, and on each of the two circumferential sides of the butt joint is firmly bonded with an exposed surface section of the tube laminate in the end regions.

29. A Tube with the tubular body according to claim 28 and furthermore with a tube top bonded with the tubular body which exhibits at least one exposed surface from a polyolefin encircling the tubular body longitudinal axis, where an exposed surface of the tubular body is firmly bonded through sealing with the encircling exposed surface of the tube top.
